(19) United States
(12) Patent Application Publication
(10) Pub. No.: US 2006/0215394 A1
(43) Pub. Date: Sep. 28, 2006

(54) Key cap having integral LED

(75) Inventor: Donald F. Evans, Pinehurst, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Cyberlux Corporation

(21) Appl. No.: 11/089,073

(22) Filed: Mar. 24, 2005

(51) Int. Cl. F21V 33/00

(52) U.S. Cl. 362/116; 362/800

(57) ABSTRACT

The present invention is directed to a key cap light assembly that produces an efficient beam of light and is adaptable to a variety of key types. The key cap light has an elastomeric sleeve that is adapted to enclose a variety of key heads having different sizes, shapes, and thicknesses. The elastomeric sleeve binds an LED assembly to the key to provide an energy efficient, operator-activated, light source proximate the key.

### BACKGROUND OF THE INVENTION

1. Field of the Invention

The present invention relates to an illumination device generally, and more particularly to a key cap light that is adaptable to a multitude of key types and is capable of illuminating a darkened lock or keyhole.

2. Description of the Related Art

Light emitting diodes (LEDs) have become a viable alternative to conventional light sources. Current LED technology provides high levels of lumen output while drawing several times less energy than conventional incandescent or florescent light sources. LEDs are also much smaller than traditional light sources. Such improvements have led to LED usage in a variety of applications. For example, numerous LED-equipped key lights are known. Such devices are generally intended to illuminate a lock or keyhole in a darkened environment. Unfortunately, however, each of the known LED-equipped key lights suffer from one or more drawbacks. For example, prior art LED-equipped key lights are generally not attachable to standard, factory-produced keys without significant machining or other costly modification. Key lights that are attachable to factory-produced keys are generally limited to use with keys of a specific size, shape, and thickness. Finally, LED-equipped key lights that operate with factory-produced keys of different sizes, shapes, and thickness generally require use of fasteners, such as screws, clips, welds, or sticky adhesives to attach the LED light to the key. Such fasteners are undesirable as they are generally susceptible to corrosion or degradation when exposed to common environmental elements such as moisture and dirt.

It would be desirable then to provide a durable LED-equipped key light that is structured to provide an efficient beam of light for illuminating a keyhole in a darkened environment. It is further desirable to provide an LED-equipped key light that is readily adaptable to a variety of standard key sizes, shapes and thicknesses. Finally, it is desirable to produce an LED-equipped key light that is attachable to standard, factory-produced, keys without a need for metal fasteners or tacky adhesives.

### BRIEF SUMMARY OF THE INVENTION

The present invention addresses the above needs and achieves other advantages by providing a key cap light assembly that produces an efficient beam of light and is adaptable to a variety of key types. The key cap light has an elastomeric sleeve that is adapted to enclose a variety of key heads having different sizes, shapes, and thicknesses. For purposes of the foregoing specification and appended claims the term “elastomeric” refers to materials that readily resume a formed shape after being stretched or expanded. The elastomeric sleeve binds an LED assembly to the key to provide an energy efficient, operator-activated, light source proximate the key.

In one embodiment, the key cap light comprises an elastomeric sleeve structured to at least partially enclose a key head, a pocket defined in the elastomeric sleeve, and a light emitting diode (LED) assembly disposed at least partially within the pocket. The LED assembly may comprise at least one LED, at least one battery, and at least one activator for operatively engaging the LED assembly.

In one embodiment, the present invention is directed to a key cap light adapted to fit a first key having a first key head size and a second key having a second key head size. The key cap light includes an elastomeric sleeve adaptable to a first position for receiving the first key having the first key head size, and further adaptable to a second position for receiving the second key having a second key head size. In another embodiment, a pocket is defined in the elastomeric sleeve and a light emitting diode (LED) assembly is disposed at least partially within the pocket. The LED assembly includes at least one LED and corresponding electrical circuitry. In one embodiment, the LED assembly includes an electrochemical energy source, such as a battery, and an activator that allows a user to operatively engage the LED assembly.

The elastomeric sleeve of the key cap light defines a formed or rest position. As the second key head size may be larger than the first key head size or vice versa, the elastomeric sleeve is adaptable to stretching to first and second positions. The elastomeric sleeve is not generally stretched in the rest position. In various embodiments, the elastomeric sleeve is comprised at least partially of spandex, neoprene, or other similar elastomeric materials.

The key cap light of the present invention provides several advantages. The key cap light includes an elastomeric sleeve structured to couple the key cap light to a variety of keys regardless of their size, shape, or thickness. Advantageously, the key cap light of the present invention does not require use of complex fasteners, attachment tools or tacky adhesives. The key cap light of the present invention also includes an LED assembly for providing an efficient, operator-activated, beam of light proximate the blade of a standard factory-produced key.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of first and second keys according to the known prior art;

FIG. 2 is a perspective view of a key cap light adapted to at least partially enclose the first key of FIG. 1 in accordance with one embodiment of the present invention;

FIG. 3 is an exploded view of a key cap light in accordance with one embodiment of the present invention;

FIG. 4 is a top view of a key cap light in accordance with one embodiment of the present invention;

FIG. 5 is a bottom view of a key cap light in accordance with one embodiment of the present invention;

FIG. 6 is a section view of a key cap light, taken along section lines 6-6 of FIG. 4, in accordance with one embodiment of the present invention;

FIG. 7 is a top view of a transversely stretched key cap light elastomeric sleeve in accordance with one embodiment of the present invention;

FIG. 8 is a top view of a longitudinally stretched key cap light elastomeric sleeve in accordance with another embodiment of the present invention; and

FIG. 9 is a perspective view of a key cap light adapted to at least partially enclose the second key of FIG. 1 in accordance with another embodiment of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

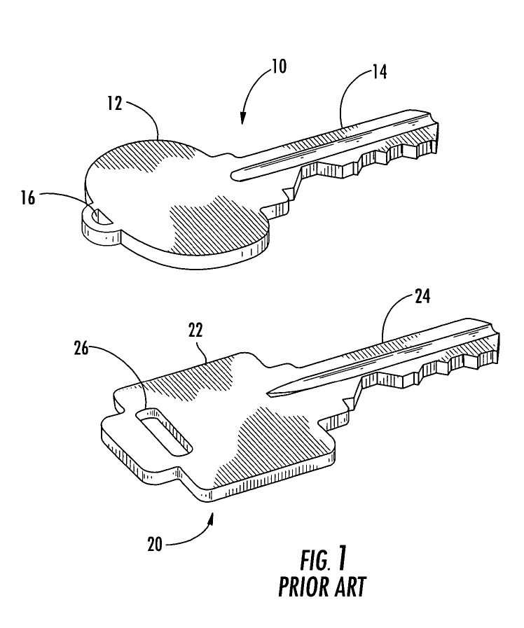

Conventional keys of the type needed to open locks disposed in doors, cars, safety deposit boxes, and the like, are commonly manufactured in a variety of different sizes, shapes, and thicknesses. FIG. 1 depicts two such conventional keys. A first key 10 includes an oval-shaped head 12 extending from a key blade 14 as shown. In many applications, a key ring aperture 16 is defined at one end of the key. The key ring aperture is structured to receive a key ring (not shown) for binding one or more keys together as will be apparent to one of ordinary skill in the art. A second key 20 is depicted having a rectangular shaped head 22 extending from a key blade 24 as shown. The second key 20 also defines a key ring aperture 26 proximate one end of the key. As is apparent in view of the standard keys illustrated in FIG. 1, the size, shape, and thickness of respective key heads may vary significantly between applications. This result is generally intended by key manufacturers as such varying features allow consumers to differentiate between keys having different purposes (e.g., house keys, car keys, pad lock keys, etc.).

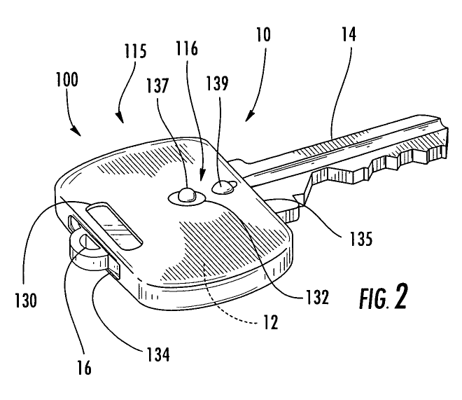

FIG. 2 depicts a key cap light assembly 100 coupled to a conventional key in accordance with one embodiment of the present invention. For purposes of simplicity, the foregoing specification and appended claims will refer to the key cap light assembly as a key cap light. In the depicted embodiment, the key cap light 100 is coupled to the first key 10 of FIG. 1 for illustration purposes. As will be apparent in view of the disclosure provided below, key cap lights 100 in accordance with various embodiments of the present invention are not limited to use with any one key head structure and are designed specifically to enclose key heads of varying sizes and shapes. In this regard, FIG. 9 depicts a key cap light 200 coupled to the second key 20 of FIG. 1 as discussed in greater detail below.

In the embodiment depicted in FIG. 2, the key cap light 100 is comprised of an elastomeric sleeve 115 and an LED assembly 116. The elastomeric sleeve 115 is structured to stretch over, and at least partially enclose, the head 12 of a standard key 10, thereby binding the key cap light 100 to the key 10. In various embodiments, the elastomeric sleeve 115 defines a number of apertures as described in detail below. In one embodiment, for example, the elastomeric sleeve 115 defines a key blade aperture 135. The key blade aperture is structured to receive a key blade 14. In another embodiment, the elastomeric sleeve 115 defines a key head aperture 134. The key head aperture 134 is structured to receive a portion of the key head 12. In such embodiments, the elastomeric sleeve 115 (and thus the key cap light 100) is secured at a first end by the key blade extending through the key blade aperture 135, and secured at a second end by a portion of the key head 12 extending through the key head aperture 134. The second element of the key cap light 100 is the LED assembly 116. The LED assembly 116 includes at least one LED 139 and corresponding electrical circuitry. In one embodiment, the at least one LED 139 is directed to illuminate an area proximate the blade 14 of an attached key 10. To operate the key cap light 100, a user simply directs the key blade 14 toward a selected key hole (not shown). An engaged LED 139 is thus positioned to illuminate the selected key hole.

FIG. 3 depicts an exploded view of a key cap light 100 in accordance with another embodiment of the present invention. As referenced above, the key cap light 100 is comprised of an elastomeric sleeve 115 and an LED assembly 116. In one embodiment, the elastomeric sleeve 115 comprises one or more elastomeric materials such as spandex materials including those sold by Du Pont under the LYCRA® brand, neoprene materials, or other stretchable nylon or polyester blended materials. Apart from their elasticity, such materials provide resistance to moisture and other environmental contaminants. In various embodiments, the elastomeric sleeve 115 may be structured generally as a pouch, cup, or band.

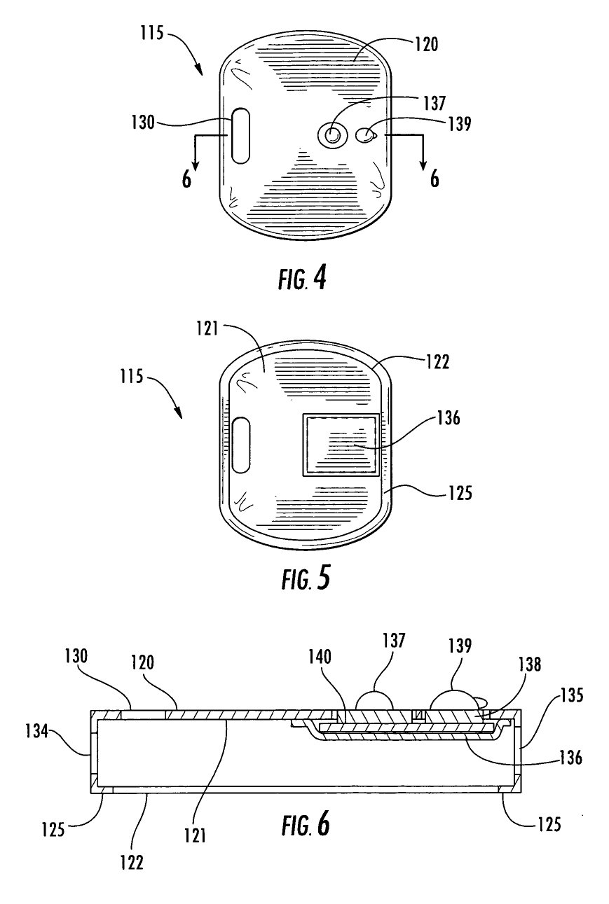

In the depicted embodiment, the elastomeric sleeve 115 is structured generally as an inverted cup. The elastomeric sleeve 115 includes an outer surface 120 having a rim portion 125 at least partially enclosing an inner surface (as shown in greater detail in FIG. 5). In one embodiment, the rim portion 125 of the elastomeric sleeve 115 defines a rest position that is smaller than the key head 12 of the first key 10 and smaller than the key heads of other standard factory-produced keys (not shown). Such sizing allows the elastomeric sleeve 115 to stretch from the rest position to a stretched position whereby the elastomeric sleeve 115 at least partially encloses the key head 12 as shown in FIG. 2. Such sizing is best illustrated through a comparison of the elastomeric sleeve positions shown in FIG. 2 and FIG. 3. FIG. 3 depicts an elastomeric sleeve 115 in a rest position while FIG. 2 illustrates the elastomeric sleeve 115 stretched to a first position in which the elastomeric sleeve 115 has been installed to partially enclose the key head 12 of the first key 10. Once installed, the elastomeric sleeve 115 snugly fits the key head 12 in order to firmly hold the key cap light 100 to the key. As a result, the key cap light 100 of the present invention has little need for undesirable fasteners or tacky adhesives.

In one embodiment of the invention, as referenced briefly above, the elastomeric sleeve 115 defines a key blade aperture 135. The key blade aperture 135 is sized to receive key blades 14 of differing keys. In the depicted embodiment, the shape of the key blade aperture 135 is rectangular; however, in alternate embodiments key blade apertures 135 may take any shape large enough to receive a key blade 14. In another embodiment, the elastomeric sleeve 115 defines a key head aperture 134 positioned generally opposite the key blade aperture 135 as shown. In the depicted embodiment, the key head aperture 134 is a rectangular slot, however, the key head aperture 134 may take any shape capable of receiving a portion of the key head 12. In this regard, the elastomeric sleeve 115 is held to the key head 12 by at least three points, namely, the point at which the key blade 14 extends through the key blade aperture 135, the point at which a portion of the key head 12 extends through the key head aperture 134, and the point at which the rim portion 125 of the elastomeric sleeve 115 at least partially encloses the key head 12.

In the depicted embodiment, the key head aperture 134 additionally provides a user access to the key ring aperture 16 as shown. In alternate embodiments, however, an optional ring aperture 130 may be required to provide such access in differently configured keys (as shown in FIG. 9).

In another embodiment, as shown collectively in FIG. 3 and FIG. 6, the elastomeric sleeve 115 defines a pocket 136 for receiving the LED assembly 116 as described in further detail below. The depicted LED assembly 116 comprises at least one LED 139, an activator 137 for activating the at least one LED 139, a battery 138 for powering the at least one LED 139, and a circuit board 140 for controlling the at least one LED 139. For simplicity purposes, the at least one LED 139 is referred to below as the LED 139. It is noted however, that the present invention is not limited to key cap lights having a single LED and may, in fact, include key cap lights having multiple LEDs.

Although depicted as a button, the activator 137 may include alternate devices or switches that allow users to selectively engage the LED 139. For example, the activator 137 may include buttons, dials, optical sensors, thumb wheels, and the like. Likewise, the LED 139 of the depicted embodiment is a white LED; however, it should be understood by one skilled in the art that the LED 139 may be any other type of LED or combination of LEDs, including but not limited to blue LEDs, red LEDs, orange LEDs, amber LEDs, yellow LEDs, green LEDs, or bi- or tri-color LEDs. The depicted battery 138 is a flat lithium battery, however, other batteries known in the art may be used.

In the depicted embodiment, the activator 137, the battery 138, and the LED 139 are disposed in electrical communication via a circuit board 140. The circuit board 140 supports corresponding electrical circuitry for driving the LED 139 to illuminate in response to a user pressing or otherwise operatively engaging the activator 137. In the depicted embodiment, the circuit board 140 is a small printed circuit board or PCB.

In one embodiment of the present invention, the elastomeric sleeve 115 defines an activator aperture 132 and an LED aperture 133 as shown. The depicted activator aperture 132 is structured to provide a user access to the activator 137. Alternatively, in other embodiments, the activator aperture 132 may be omitted as the activator may be operated by a user through the elastomeric sleeve, e.g., via a rocker switch or other devices (not shown). In the depicted embodiment, the LED aperture 133 is structured to provide an unimpeded beam of light from the LED 139 toward the blade 14 of an attached key.

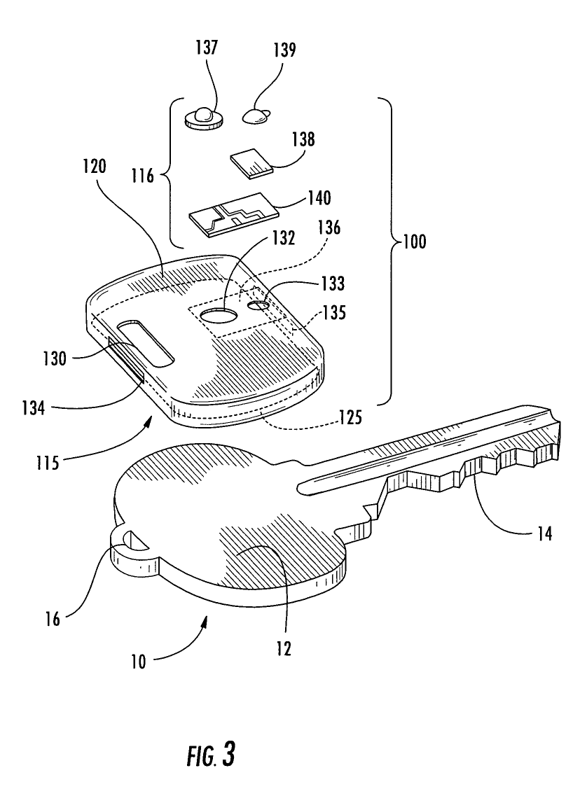

Referring to FIG. 4 and FIG. 5, the elastomeric sleeve 115 is shown in its rest or un-stretched state. As referenced above, the depicted elastomeric sleeve 115 is structured generally as an inverted a cup having an outer surface 120 defining a rim portion 125 that at least partially encloses an inner surface 121. The rim portion 125 of the elastomeric sleeve 115 defines an access aperture 122 as shown. In one embodiment, the access aperture 122 exposes a pocket 136 located on the inner surface 121 of the elastomeric sleeve 115. The pocket 136 operates to enclose, support, isolate, and protect the LED assembly 116. In the depicted embodiment, the pocket 136 is comprised of an elastomeric material that is stitched to the inner surface 120 of the elastomeric sleeve 115. In alternate embodiments, however, the pocket 136 may be formed integrally within the inner surface 120 of the elastomeric sleeve 115. For example, the pocket 136 may molded as a unitary part of the elastomeric sleeve 115 such that no stitching or other attachment is necessary (not shown). The pocket 136 may be comprised of any material sufficient to enclose and isolate the LED assembly 116 from water, dirt, or other contaminants. Elastomeric materials (e.g., spandex, neoprene, blended polyester, nylon, etc.) may be particularly useful as pocket materials as they allow the pocket to stretch in unison with the elastomeric sleeve, thus, reducing strain on the attachment area between the pocket and the elastomeric sleeve.

Referring to FIG. 5 and FIG. 6, the depicted pocket 136 is located generally centrally on the inner surface 121 of the elastomeric sleeve 115 and slightly proximate the key blade aperture 135. In alternate embodiments, the pocket 136 may be located anywhere on the inner surface 121 of the elastomeric sleeve 115. Further, in other embodiments, the pocket 136 may be disposed on the outer surface 120 of the elastomeric sleeve 115 (not shown). In such embodiments, the pocket 136 may define apertures for exposing the activator 137 and the LED 139.

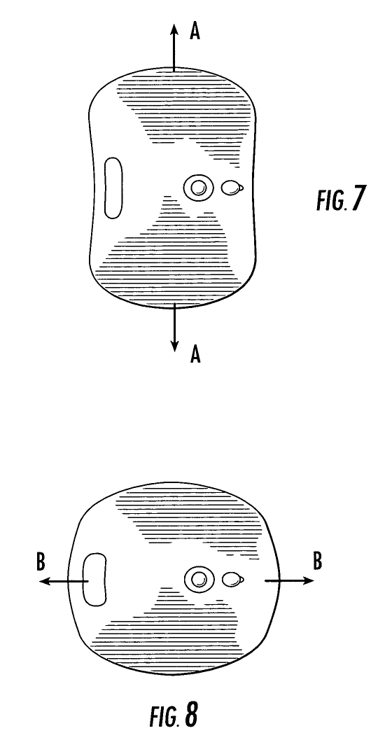

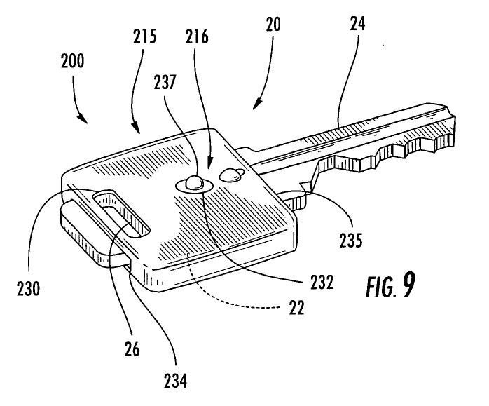

FIG. 7 and FIG. 8 depict the longitudinal and transverse elasticity of the elastomeric sleeve 115. In one embodiment, as illustrated in FIG. 7, the elastomeric sleeve 115 is adapted to stretch transversely from a rest position along arrows A-A. Such transverse elasticity allows the elastomeric sleeve to receive key heads of differing shapes, widths, and thicknesses. In another embodiment, as shown in FIG. 8, the elastomeric sleeve 115 is adapted to stretch longitudinally from a rest position along arrows B-B. Such longitudinal elasticity allows the elastomeric sleeve to receive key heads of differing shapes, lengths, and thicknesses.

Returning briefly to FIG. 2, the depicted key cap light 100 is coupled to the first key 10 at least partially because of the transverse and longitudinal elasticity demonstrated in FIG. 7 and FIG. 8. The key cap light 100 is stretched from a rest position to the first position depicted in FIG. 2 generally as described below. The first key 10 is placed into the access opening of the elastomeric sleeve 115 (shown as 122 in FIG. 5) and the key blade 14 is inserted into the key blade aperture 135 as shown. The elastomeric sleeve 115 is stretched transversely such that the key head 12 is received within the access aperture. The elastomeric sleeve 115 is stretched longitudinally such that a portion of the key head 12 is received by, and locked into, the key head aperture 134 as shown. In the depicted embodiment, the elastomeric sleeve 115 defines an activator aperture 132 that allows a user to operatively engage the activator 137.

Similarly, FIG. 9 depicts a key cap light 200 adapted to stretch transversely and longitudinally to a second position for fitting the second key 20 of FIG. 1. In the depicted embodiment, the second key 20 is placed into the access opening of the elastomeric sleeve (shown as 122 in FIG. 5) and the key blade 24 is inserted into the key blade aperture 235 as shown. The elastomeric sleeve 215 is stretched transversely such that the key head 22 is received within the access aperture. The elastomeric sleeve 215 is stretched longitudinally such that a portion of the key head 22 is received by, and locked into, the key head aperture 234 as shown. In the depicted embodiment, the elastomeric sleeve 215 defines an activator aperture 232 that allows a user to operatively engage the activator 237. In addition, the depicted elastomeric sleeve 215 defines a key aperture 230 for aligning with the key ring aperture 26 of the key and thereby allowing use of a key ring (not shown) with the key cap light 200 of the present invention.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A key cap light adapted for use with keys having key heads of various sizes and shapes, said key cap light comprising:
an elastomeric sleeve structured to at least partially enclose a key head;
a pocket defined in said elastomeric sleeve; and
a light emitting diode (LED) assembly disposed at least partially within said pocket.

2. The key cap light of claim 1, wherein said LED assembly comprises at least one LED.

3. The key cap light of claim 1, wherein said LED assembly comprises at least one battery.

4. The key cap light of claim 1, wherein said LED assembly comprises at least one activator for operatively engaging said LED assembly.

5. A key cap light adapted to fit a first key having a first key head size and a second key having a second key head size, said key cap light comprising:
an elastomeric sleeve adaptable to a first position for receiving the first key having the first key head size, and further adaptable to a second position for receiving the second key having a second key head size;
a pocket defined in said elastomeric sleeve; and
a light emitting diode (LED) assembly disposed at least partially within said pocket.

6. The key cap light of claim 5, wherein said LED assembly comprises at least one LED.

7. The key cap light of claim 5, wherein said LED assembly comprises at least one battery.

8. The key cap light of claim 5, wherein said LED assembly comprises at least one activator for operatively engaging said LED assembly.

9. The key cap light claim 5, wherein the second key head size is larger than the first key head size and said elastomeric sleeve is stretched to said second position for receiving the second key having the second key head size.

10. The key cap light of claim 5, wherein said elastomeric sleeve is formed having a rest position and wherein said elastomeric sleeve is stretched from the rest position to the first position for receiving the first key having the first key head size.

11. The key cap light of claim 5, wherein said elastomeric sleeve is comprised at least partially of spandex.

12. The key cap light of claim 5, wherein said elastomeric sleeve is comprised at least partially of neoprene.

13. A key cap light adapted to fit a first key having a first key head size and a second key having a second key head size, said key cap light comprising:
an elastomeric sleeve adaptable to a first position for receiving the first key having the first key head size, and further adaptable to a second position for receiving the second key having a second key head size; and
a light emitting diode (LED) assembly releasably coupled to said elastomeric sleeve.

14. The key cap light of claim 13, wherein said LED assembly comprises at least one LED.

15. The key cap light of claim 13, wherein said LED assembly comprises at least one battery.

16. The key cap light of claim 13, wherein said LED assembly comprises at least one activator for operatively engaging said LED assembly.

17. The key cap light claim 13, wherein the second key head size is larger than the first key head size and said elastomeric sleeve is stretched to said second position for receiving the second key having the second key head size.

18. The key cap light of claim 13, wherein said elastomeric sleeve is formed having a rest position and wherein said elastomeric sleeve is stretched from the rest position to the first position for receiving the first key having the first key head size.

19. The key cap light of claim 13, wherein said elastomeric sleeve is comprised at least partially of spandex.

20. The key cap light of claim 13, wherein said elastomeric sleeve is comprised at least partially of neoprene.

21. The key cap light of claim 13, wherein said elastomeric sleeve at least partially encloses a first key head of the first key in the first position.

22. The key cap light of claim 13, wherein said elastomeric sleeve at least partially encloses a second key head of the second key in the second position.
